(19) United States
(12) Patent Application Publication
(10) Pub. No.: US 2012/0170549 A1
(43) Pub. Date: Jul. 5, 2012

(54) Method and Apparatus for System Frame Number Synchronization in Time Division-Synchronous Code Division Multiple Access (TD-SCDMA) Networks

(75) Inventors: Tom Chin, San Diego, CA (US); Guangming Shi, San Diego, CA (US); Kuo-Chun Lee, San Diego, CA (US)

(73) Assignee: QUALCOMM Incorporated, San Diego, CA (US)

(21) Appl. No.: 13/379,720

(22) PCT Filed: May 7, 2010
(86) PCT No.: PCT/US10/33996

§ 371 Date: Dec. 21, 2011

Related U.S. Application Data
(60) Provisional application No. 61/244,789, filed on Sep. 22, 2009.

(51) Int. Cl. H04B 7/212; H04W 36/00

(52) U.S. Cl. 370/331; 370/337

(57) ABSTRACT

A method, an apparatus, and a computer program product for wireless communication are provided in which a first signal from a first Node B (NB) using a first system frame number (SFN) is received; and a second signal from a second NB using a second SFN is received, wherein the first SFN and the second SFN are identical.

### CROSS-REFERENCE TO RELATED APPLICATION(S)

This application claims the benefit of U.S. Provisional Patent Application No. 61/244,789, entitled “METHOD AND APPARATUS FOR SYSTEM FRAME NUMBER SYNCHRONIZATION TD-SCDMA NETWORKS,” filed on Sep. 22, 2009, which is expressly incorporated by reference herein in its entirety.

### BACKGROUND

I. Field

Aspects of the present disclosure relate generally to wireless communication systems, and more particularly, to a method and apparatus for system frame number synchronization in time division-synchronous code division multiple access (TD-SCDMA) networks.

II. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). For example, China is pursuing TD-SCDMA as the underlying air interface in the UTRAN architecture with its existing GSM infrastructure as the core network. The UMTS also supports enhanced 3G data communications protocols, such as High Speed Downlink Packet Data (HSDPA), which provides higher data transfer speeds and capacity to associated UMTS networks.

As the demand for mobile broadband access continues to increase, research and development continue to advance the UMTS technologies not only to meet the growing demand for mobile broadband access, but to advance and enhance the user experience with mobile communications.

The China Communications Standard Association (CCSA) has published a series of TDD-based 3G standards for TD-SCDMA. In TD-SCDMA systems, the user equipment (UE) needs to perform a random access procedure as the first procedure to contact the network. The UL synchronization or random access procedure is defined in the CCSA standards YD/T 1371.5-2008 Technical requirements for Uu Interface of 2 GHz TD-SCDMA Digital Cellular Mobile Communication Network Physical Layer Technical Specification Part 5: Physical Layer Procedure.

It would be preferable to provide additional UL synchronization and random access procedures to the existing system.

### SUMMARY

In an aspect of the disclosure, a method of wireless communication is provided. The method includes receiving a first signal from a first Node B (NB) using a first system frame number (SFN); and receiving a second signal from a second NB using a second SFN, wherein the first SFN and the second SFN are identical.

In an aspect of the disclosure, an apparatus for wireless communication includes means for receiving a first signal from a first NB using an SFN; and means for receiving a second signal from a second NB using a second SFN, wherein the first SFN and the second SFN are identical.

In an aspect of the disclosure, a computer program product includes a computer-readable medium including code for receiving a first signal from a first NB using an SFN; and receiving a second signal from a second NB using a second SFN, wherein the first SFN and the second SFN are identical.

In an aspect of the disclosure, an apparatus for wireless communication includes a processor. The processor is configured to receive a first signal from a first NB using an SFN; and receive a second signal from a second NB using a second SFN, wherein the first SFN and the second SFN are identical.

### BRIEF DESCRIPTION OF THE DRAWINGS

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a Node B (NB) in communication with a user equipment (UE) in a telecommunications system.

FIG. 4 is a functional block diagram conceptually illustrating example blocks executed to implement the functional characteristics of one aspect of the present disclosure.

FIG. 5 is a timing diagram conceptually illustrating an example operation of the communication system without system frame number (SFN) synchronization.

FIG. 6 is a flow diagram conceptually illustrating an example operation of the communication system to achieve SFN synchronization configured in accordance with one aspect of the present disclosure.

FIG. 7 is a flow diagram conceptually illustrating an example operation of the UE to achieve SFN synchronization configured in accordance with one aspect of the present disclosure.

FIG. 8 is a timing diagram conceptually illustrating an example operation of the communication system with SFN synchronization configured in accordance with one aspect of the present disclosure.

FIG. 9 is a conceptual block diagram illustrating the functionality of an exemplary UE apparatus for synchronizing SFN in accordance with one aspect of the disclosure.

### DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

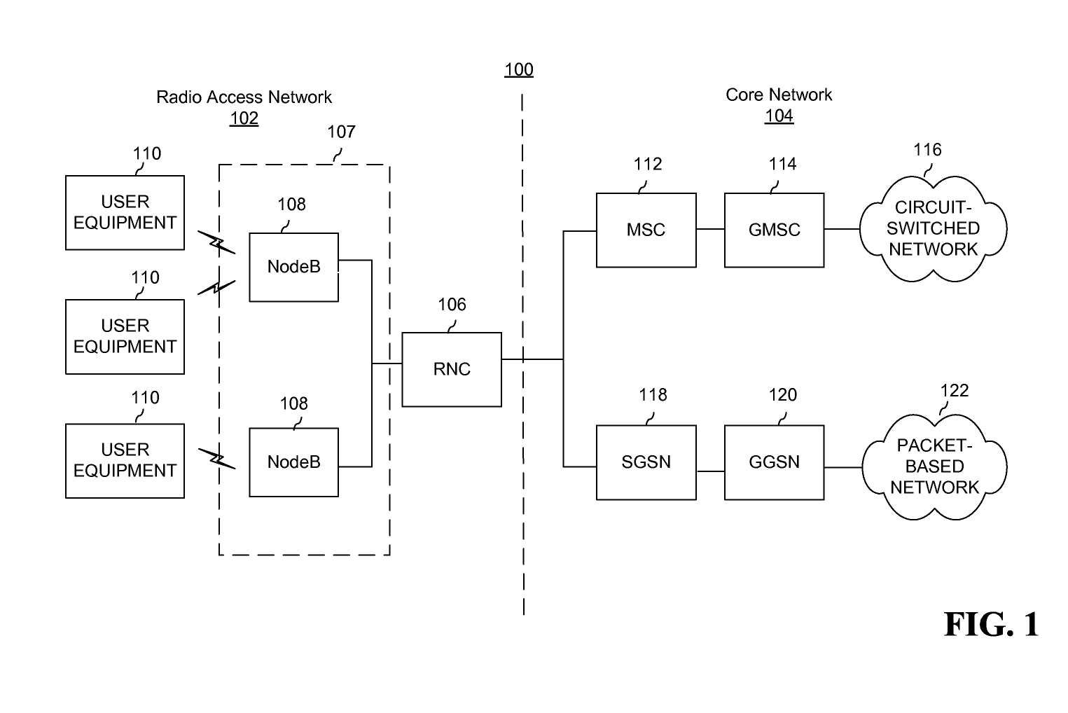

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of Radio Network Subsystems (RNSs) such as an RNS 107, each controlled by a Radio Network Controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a NB in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two NBs 108 are shown; however, the RNS 107 may include any number of wireless NBs. The NBs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the NBs 108. The downlink (DL), also called the forward link, refers to the communication link from a NB to a UE, and the uplink (UL), also called the reverse link, refers to the communication link from a UE to a NB.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a NB 108 and a UE 110, but divides uplink and downlink transmissions into different time slots in the carrier.

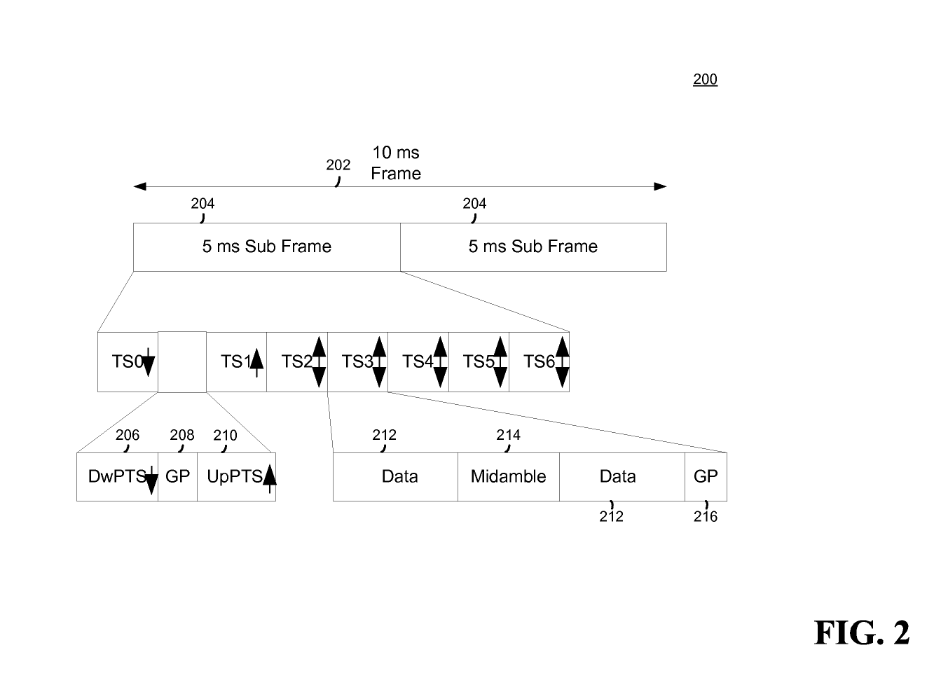

FIG. 2 shows a frame structure 200 for a TD-SCDMA carrier. The TD-SCDMA carrier, as illustrated, has a frame 202 that is 10 ms (ms) in length. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 separated by a midamble 214 and followed by a guard period (GP) 216. The midamble 214 may be used for features, such as channel estimation, while the GP 216 may be used to avoid inter-burst interference.

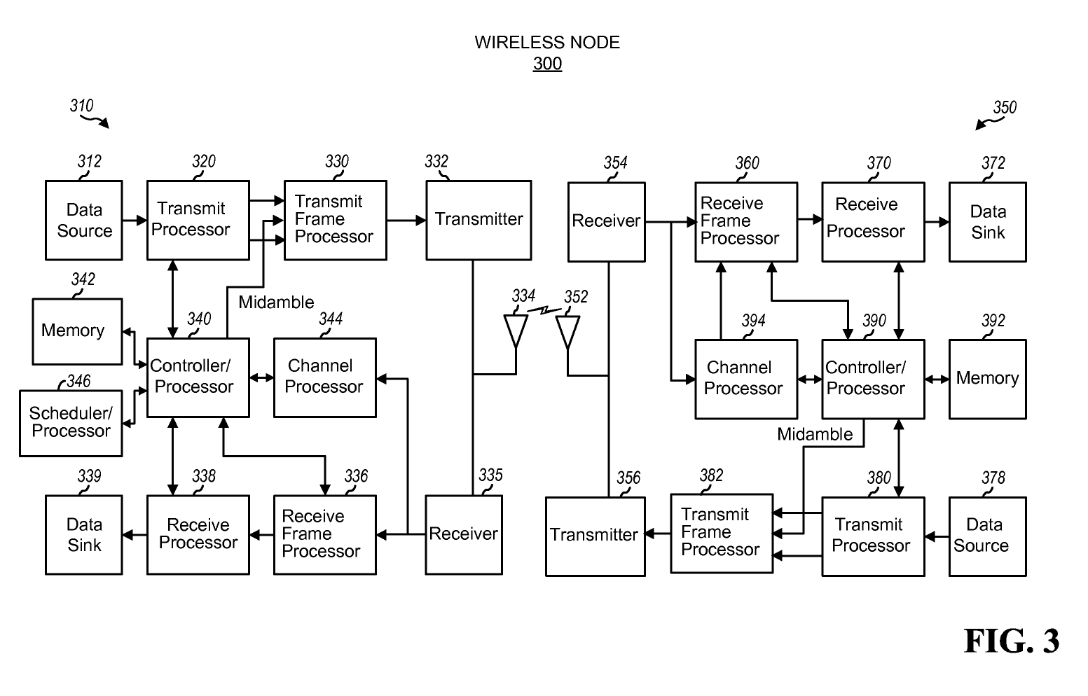

FIG. 3 is a block diagram of a NB 310 in communication with a UE 350 in a RAN 300, where the RAN 300 may be the RAN 202 in FIG. 2, the NB 310 may be the NB 208 in FIG. 2, and the UE 350 may be the UE 210 in FIG. 2. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through one or more antennas 334. The one or more antennas 334 may be implemented with beam steering bidirectional adaptive antenna arrays or other similar beam technologies.

At the UE 350, a receiver 354 receives the downlink transmission through one or more antennas 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the NB 310. More specifically, the receive processor 370 descrambles and despreads the symbols, and then determines the most likely signal constellation points transmitted by the NB 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receiver processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the NB 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the NB 310 or from feedback contained in the midamble transmitted by the NB 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the one or more antennas 352.

The uplink transmission is processed at the NB 310 in a manner similar to that described in connection with the receiver function at the UE 350. A receiver 335 receives the uplink transmission through the one or more antennas 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the NB 310 and the UE 350, respectively. For example, the controller/processors 340 and 390 may provide various functions including timing, peripheral interfaces, voltage regulation, power management, and other control functions. The computer readable media of memories 342 and 392 may store data and software for the NB 310 and the UE 350, respectively. A scheduler/processor 346 at the NB 310 may be used to allocate resources to the UEs and schedule downlink and/or uplink transmissions for the UEs.

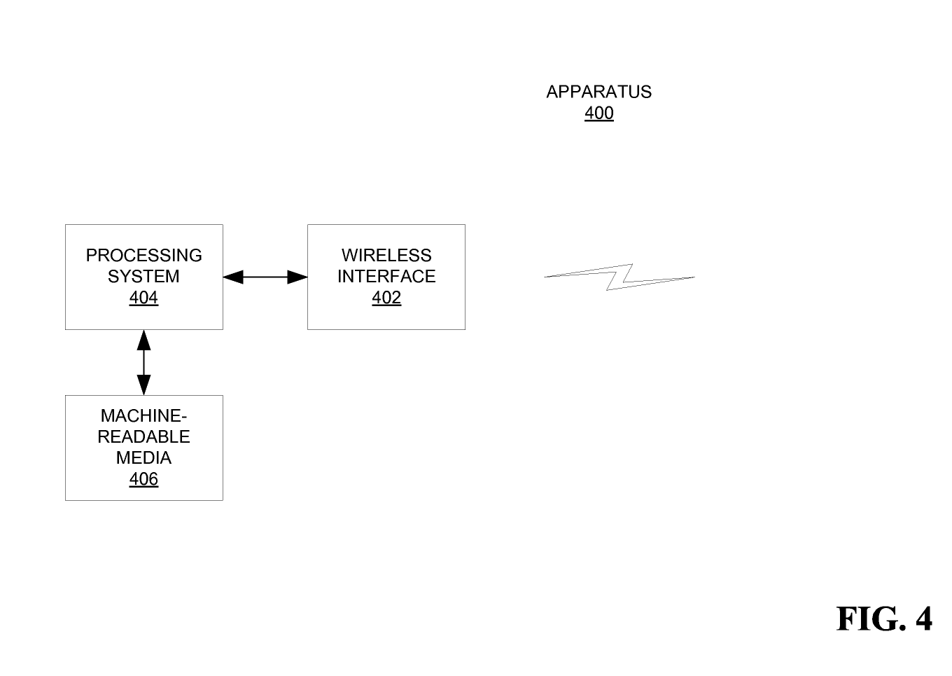

FIG. 4 is a block diagram illustrating a configuration for an apparatus 400, which can be a UE 110. The apparatus 400 may include a wireless interface 402, a processing system 404, and machine-readable media 406. The wireless interface 402 may be integrated into the processing system 404 or distributed across multiple entities in the apparatus. The processing system 404 may be implemented with one or more processors. The one or more processors may be implemented with any combination of general-purpose microprocessors, microcontrollers, digital signal processors (DSPs), digital signal processing devices (DSPDs), field programmable gate array (FPGAs), programmable logic devices (PLDs), controllers, integrated circuits (ICs), application specific ICs (ASICs), state machines, gated logic, discrete hardware components, or any other suitable entities that can perform calculations or other manipulations of information.

The processing system 404 is coupled to machine-readable media 406 for storing software. Alternatively, the processing system 404 may itself include the machine-readable media 406. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system 404 to perform the various functions described below, as well as various protocol processing functions.

When the embodiments are implemented in software, firmware, middleware or microcode, program code or code segments, they can be stored in a machine-readable medium, such as a storage component. A code segment can represent a procedure, a function, a subprogram, a program, a routine, a subroutine, a module, a software package, a class, or any combination of instructions, data structures, or program statements. A code segment can be coupled to another code segment or a hardware circuit by passing and/or receiving information, data, arguments, parameters, or memory contents. Information, arguments, parameters, and/or data can be passed, forwarded, or transmitted using any suitable means including memory sharing, message passing, token passing, and network transmission.

For a software implementation, the techniques described herein can be implemented with modules (e.g., procedures, functions, and so on) that perform the functions described herein. The software codes can be stored in memory units and executed by processors. The memory unit can be implemented within the processor or external to the processor, in which case it can be communicatively coupled to the processor via various means as is known in the art.

In a TD-SCDMA network configured in accordance with an aspect of the disclosure, the NBs are synchronous. That is, each NB transmits frames along the same frame boundaries, which in one aspect is a 10 ms boundary, as previously discussed with reference to FIG. 2. Each cell associates each frame with a system frame number (SFN) counter that starts from 0 to 4095, which restarts from 0 when reaching 4095. The SFN information is transmitted in the system information message by the NB regularly. When a UE receives this message, it can acquire the SFN for this NB.

The SFN is the basis for frame reference. One dependent operation is DRX (Discontinuous Reception), in which that, in idle mode, a UE can listen to the paging messages at some recurrent system frame number N, satisfying the following equation:

N modulo DRX_Cycle_Length=Offset

where the Offset may depend on the UE's International Mobile Subscriber Identity (IMSI).

Although the framing between NBs is synchronous, for TD-SCDMA systems that follow the UMTS standard, the SFN is not synchronous among NBs. That means, at any time, different NBs may have different SFN values. Since different NBs have different SFNs, the UE has to adjust its SFN and the new paging timeline during selection/reselection of a cell in idle mode. This creates more works for the UE because it must update the SFN and paging monitoring schedule when changing NBs. In addition, there may also be a risk that the UE may miss some paging messages.

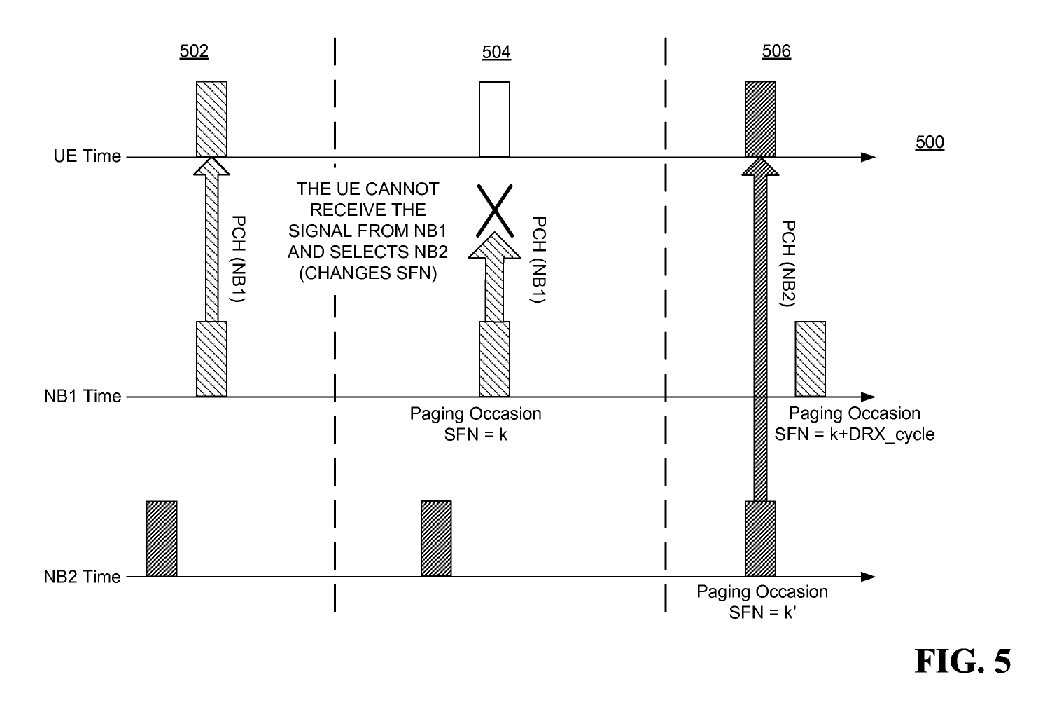

FIG. 5 illustrates a timing diagram 500 for a network in which a UE may communicate with an NB1 and an NB2. During a period 502, the UE communicates with the NB1 on a paging channel (PCH) with a SFN from the NB1. The PCH is a downlink transport channel that is transmitted over the entire cell. The transmission of the PCH is associated with the transmission of physical-layer generated paging indicators, to support efficient sleep-mode procedures.

During period 504, which is after the UE has entered into a paging occasion of the DRX cycle, the UE attempts a paging operation to contact NB1 on a PCH with a SFN, represented by k. However, the UE cannot receive the signal from NB1 and attempts to select NB2. Because NB2 uses a different SFN, the UE has to acquire the SFN for NB2, which may subject the UE to the issues described above. This is performed in 506, where the UE receives the SFN for NB2, represented by k′.

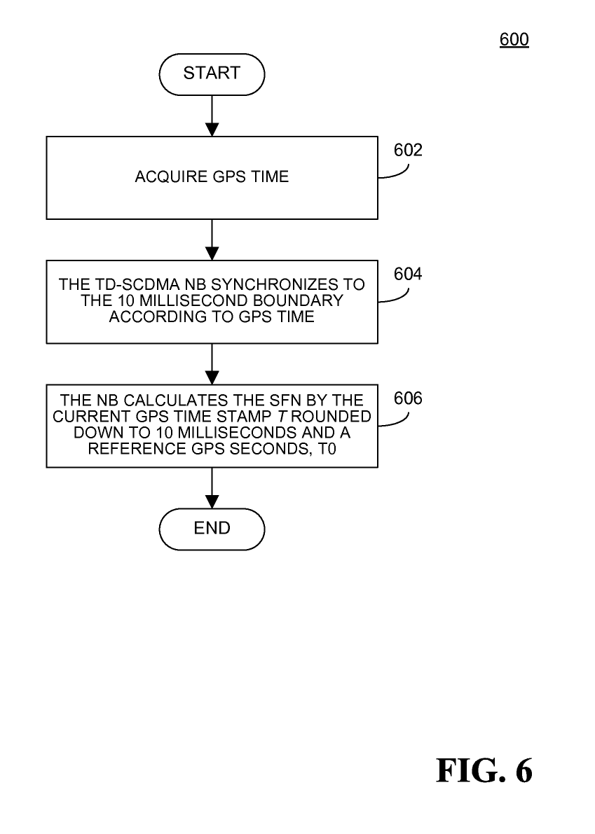

FIG. 6 illustrates a procedure 600 to allow frame and SFN synchronization between different NBs, where, in step 602, a TD-SCDMA NB acquires a GPS time signal. In order to create a network with multiple NBs using a synchronized SFN, the disclosed system proposes the use of GPS timing as a common reference to calculate the SFN for each NB. GPS equipment is present to meet the current TD-SCDMA system requirement for synchronous framing, and GPS is installed with each TD-SCDMA NB.

Then, in step 604, the TD-SCDMA NB synchronizes to the ten (10) ms boundary according to the GPS time.

In step 606, the NB TD-SCDMA calculates the synchronized SFN by the current GPS time stamp T, rounded down to 10 ms and a reference GPS seconds, T0. Thus, the current frame number SFN may be determined by the following equation:

$$SFNCURRENT = \{ ⌊ \frac{T}{10 ms} ⌋ - T 0 \} modulo 4096$$

where └ ┘ is the round-off, or floor function; 10 ms is the TD-SCDMA frame length; and T0 is the reference time of SFN=zero, in units of 10 ms. For example, T0 may be zero, or midnight Jan. 1, 1970, Coordinated Universal Time (UTC). Therefore, in one aspect of the disclosure, the SFN is the number of 10 ms periods that have elapsed since midnight Jan. 1, 1970 UTC, modulo by 4096. Furthermore, the above T0 does not have to be global. The network may allow a local SFN synchronization to a common T0 on a radio network controller (RNC) basis to allow non-global synchronization.

With synchronous SFN, the UE can acquire an SFN from an NB and apply it to other NBs as well. This may avoid missing messages and frequent update of the SFN in cell selection/reselection procedure.

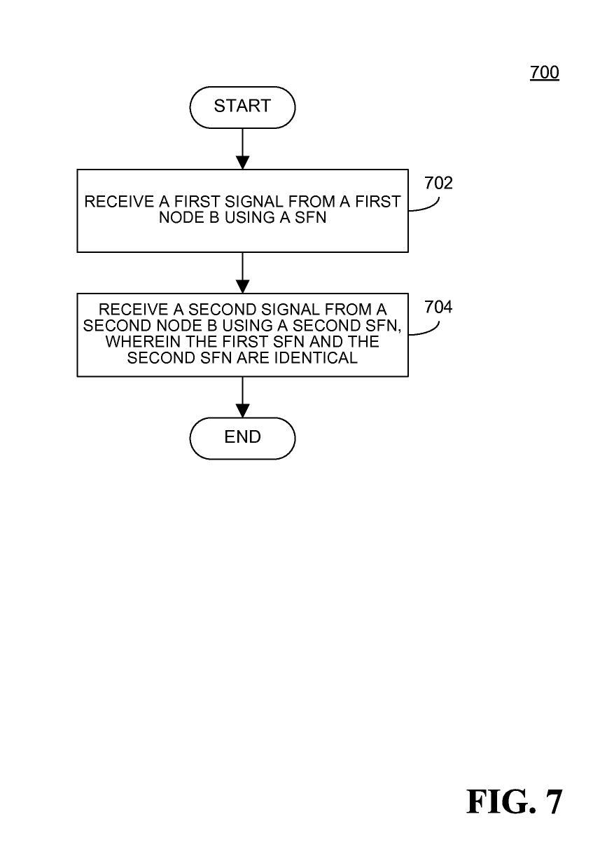

FIG. 7 illustrates a procedure 700 to utilize frame and SFN synchronization in a UE where, in step 702, the UE receives a first signal from a first NB using an SFN. In step 704, the UE receives a second signal from a second NB using a second SFN, wherein the first SFN and the second SFN are identical

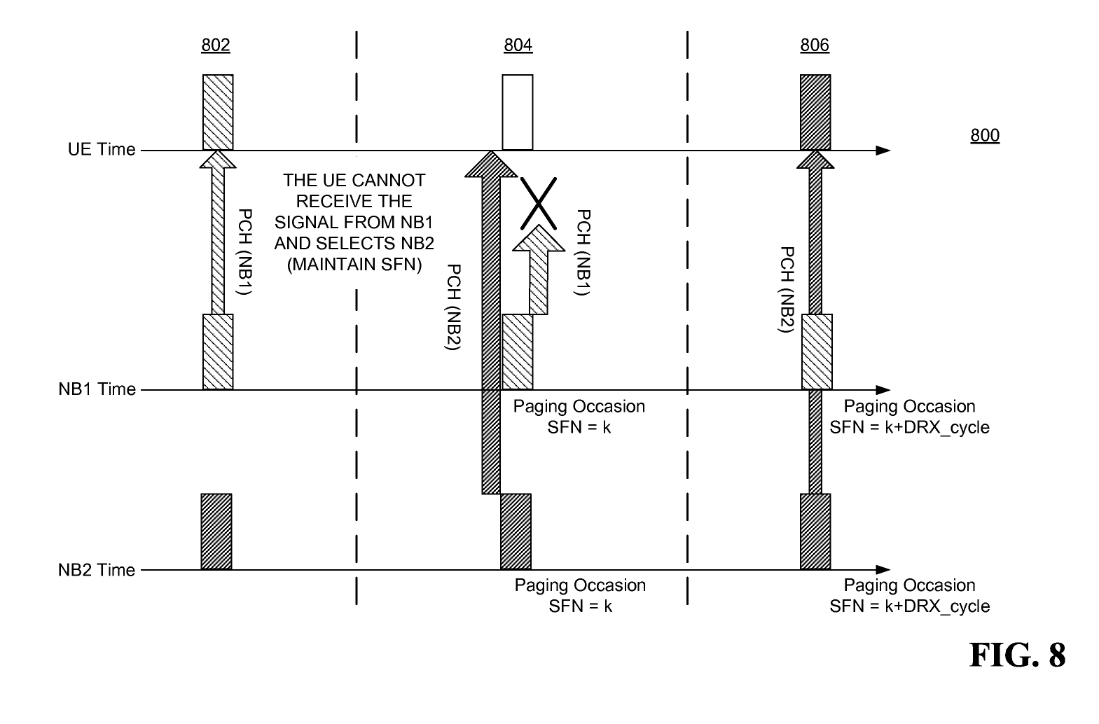

FIG. 8 illustrates a timing diagram 800 of the operation of a network with synchronized SFN. The disclosed system can allow TD-SCDMA NBs to achieve the system frame number synchronization and may reduce processing at the UE. During a period 802, the UE communicates with the NB1 on a paging channel (PCH) with a SFN from the NB1. During period 804, which is after the UE has entered into a paging occasion of the DRX cycle, the UE attempts a paging operation to contact NB1 on a PCH with a SFN, represented by k. However, the UE cannot receive the signal from NB1 and attempts to select NB2. In this case, because the SFN for NB1 and NB2 are identical, the UE does not need to acquire the SFN for NB2. For example, the UE can reduce updating the SFN and the schedule for monitoring the paging messages in idle mode. Thus, during period 806, the UE can contact NB2 using the same SFN as NB1 during a DRX_cycle.

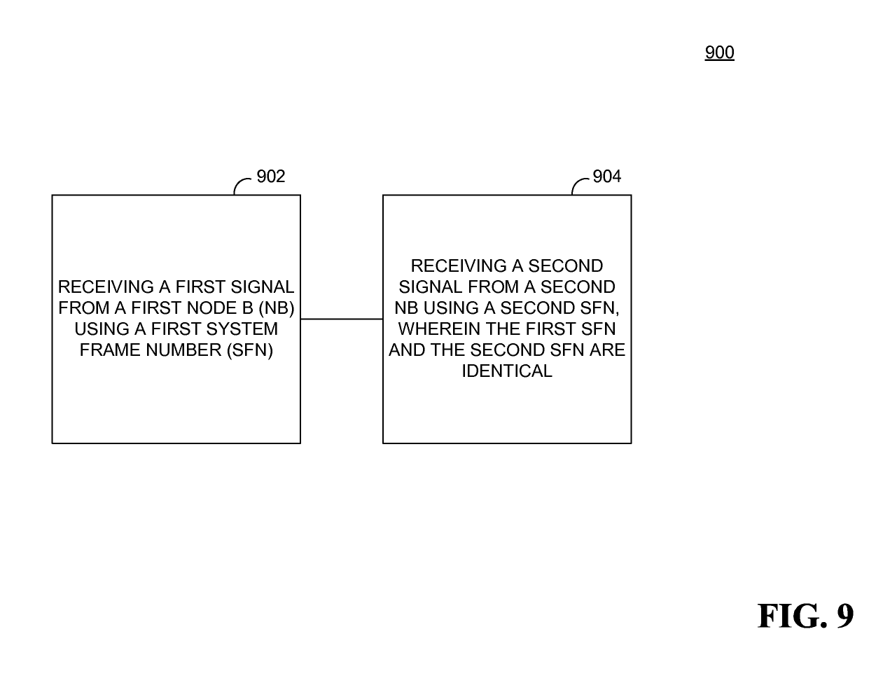

FIG. 9 is a functional block diagram 900 illustrating example blocks executed in conducting wireless communication according to one aspect of the present disclosure. In block 902, receiving a first signal from a first NB using a first SFN. In addition, block 904, receiving a second signal from a second NB using a second SFN, wherein the first SFN and the second SFN are identical.

In one configuration, the apparatus 350 for wireless communication includes means for receiving a first signal from a first NB using a first SFN; and means for receiving a second signal from a second NB using a second SFN, wherein the first SFN and the second SFN are identical. In one aspect, the aforementioned means may be the processor 390 configured to perform the functions recited by the aforementioned means. In another aspect, the aforementioned means may be a module or any apparatus configured to perform the functions recited by the aforementioned means.

Several aspects of a telecommunications system have been presented with reference to a TD-SCDMA system. As those skilled in the art will readily appreciate, various aspects described throughout this disclosure may be extended to other telecommunication systems, network architectures and communication standards. By way of example, various aspects may be extended to other UMTS systems such as W-CDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication, comprising:
receiving a first signal from a first Node B (NB) using a first system frame number (SFN); and
receiving a second signal from a second NB using a second SFN, wherein the first SFN and the second SFN are identical.

2. The method of claim 1, further comprising performing a communication transition from the first NB to the second NB.

3. The method of claim 2, wherein the communication transition is at least one of a cell reselection, an idle handover, or a handover.

4. The method of claim 1, wherein the second signal is associated with paging.

5. The method of claim 4, wherein the first signal is associated with paging.

6. The method of claim 1, wherein the receiving of the first signal from the first NB and the receiving of the second signal from the second NB occur simultaneously.

7. The method of claim 1, further comprising determining the first SFN and the second SFN.

8. The method of claim 1, wherein the receiving of the first signal from the first NB and the receiving of the second signal from the second NB occur using time division synchronous code-division multiple access (TD-SCDMA).

9. The method of claim 1, wherein the determination of the first SFN and the second SFN comprises:
locating a reference time starting point for a plurality of time periods;
determining an elapsed time period from the reference time starting point based on a current time; and
setting a SFN based on the elapsed time period.

10. The method of claim 9, wherein the elapsed time period comprises a ten (10) ms (ms) boundary.

11. The method of claim 9, wherein determining the elapsed time period comprises:
locating a reference time source;
retrieving the reference time starting point from the reference time source; and
determining a difference between the current time and the reference time.

12. The method of claim 9, wherein the current time is based on a time stamp of the reference time starting point.

13. The method of claim 12, wherein the time stamp is based on a global positioning system (GPS) time.

14. The method of claim 9, wherein setting the SFN comprises:
calculating a number of predetermined reference time periods in the elapsed time period; and
locating a remainder of the number of predetermined reference time periods based on a configurable modulo.

15. The method of claim 14, wherein the modulo is 4096.

16. A apparatus of wireless communication, comprising:
means for receiving a first signal from a first Node B (NB) using a first system frame number (SFN); and
means for receiving a second signal from a second NB using a second SFN, wherein the first SFN and the second SFN are identical.

17. The apparatus of claim 16, further comprising means for performing a communication transition from the first NB to the second NB.

18. The apparatus of claim 16, wherein the communication transition is at least one of a cell reselection, an idle handover, or a handover.

19. The apparatus of claim 16, wherein the second signal is associated with paging.

20. The apparatus of claim 19, wherein the first signal is associated with paging.

21. The apparatus of claim 16, wherein the means for receiving of the first signal from the first NB and the means for receiving of the second signal from the second NB comprises means for receiving the first and the second signals simultaneously.

22. The apparatus of claim 16, further comprising means for determining the first SFN and the second SFN.

23. The apparatus of claim 16, wherein the means for receiving of the first signal from the first NB and the means for receiving of the second signal from the second NB comprises means for using time division synchronous code-division multiple access (TD-SCDMA).

24. The apparatus of claim 16, wherein the means for determining the first SFN and the second SFN comprises:
means for locating a reference time starting point for a plurality of time periods;
means for determining an elapsed time period from the reference time starting point based on a current time; and
means for setting a SFN based on the elapsed time period.

25. The apparatus of claim 24, wherein the elapsed time period comprises a ten (10) ms boundary.

26. The apparatus of claim 24, wherein the means for determining the elapsed time period comprises:
means for locating a reference time source;
means for retrieving the reference time starting point from the reference time source; and
means for determining a difference between the current time and the reference time.

27. The apparatus of claim 24, wherein the current time is based on a time stamp of the reference time starting point.

28. The apparatus of claim 27, wherein the time stamp is based on a global positioning system (GPS) time.

29. The apparatus of claim 24, wherein the means for setting the SFN comprises:
means for calculating a number of predetermined reference time periods in the elapsed time period; and
means for locating a remainder of the number of predetermined reference time periods based on a configurable modulo.

30. The apparatus of claim 29, wherein the modulo is 4096.

31. A computer program product, comprising:
a computer-readable medium comprising code for:
receiving a first signal from a first Node B (NB) using a first system frame number (SFN); and
receiving a second signal from a second NB using a second SFN, wherein the first SFN and the second SFN are identical.

32. An apparatus for wireless communication, comprising:
a processing system configured to:
receive a first signal from a first Node B (NB) using a first system frame number (SFN); and
receive a second signal from a second NB using a second SFN, wherein the first SFN and the second SFN are identical.

33. The apparatus of claim 32, wherein the processing system is further configured to perform a communication transition from the first NB to the second NB.

34. The apparatus of claim 33, wherein the communication transition is at least one of a cell reselection, an idle handover, or a handover.

35. The apparatus of claim 32, wherein the second signal is associated with paging.

36. The apparatus of claim 35, wherein the first signal is associated with paging.

37. The apparatus of claim 32, wherein the processing system is further configured to receive the first signal from the first NB and the second signal from the second NB occur simultaneously.

38. The apparatus of claim 32, wherein the processing system is further configured to determine the first SFN and the second SFN.

39. The apparatus of claim 32, wherein the processing system is further configured to receive the first signal from the first NB and the second signal from the second NB using time division synchronous code-division multiple access (TD-SCDMA).

40. The apparatus of claim 32, wherein the processing system is further configured to:
locate a reference time starting point for a plurality of time periods;
determine an elapsed time period from the reference time starting point based on a current time; and
set a system frame number (SFN) based on the elapsed time period.

41. The apparatus of claim 40, wherein the elapsed time period comprises a ten (10) ms boundary.

42. The apparatus of claim 40, wherein the processing system is further configured to:
locate a reference time source;
retrieve the reference time starting point from the reference time source; and
determine a difference between the current time and the reference time.

43. The apparatus of claim 40, wherein the current time is based on a time stamp of the reference time starting point.

44. The apparatus of claim 43, wherein the time stamp is based on a global positioning system (GPS) time.

45. The apparatus of claim 40, wherein the processing system is further configured to:
calculate a number of predetermined reference time periods in the elapsed time period; and
locate a remainder of the number of predetermined reference time periods based on a configurable modulo.

46. The apparatus of claim 45, wherein the modulo is 4096.
